(19) United States
(12) Patent Application Publication
(10) Pub. No.: US 2021/0092223 A1
(43) Pub. Date: Mar. 25, 2021

(54) ROBOCALL DETECTION USING ACOUSTIC PROFILING

(71) Applicant: Soleo Communications, Inc., Victor, NY (US)

(72) Inventors: Daniel E. Gallagher, Fairport, NY (US); Todd A. Schmeer, Pittsford, NY (US); Jason T. Nordhaus, Rochester, NY (US); James J. Sonnick, Pittsford, NY (US); Michael G. Thorpe, Fairport, NY (US)

(21) Appl. No.: 17/116,887

(22) Filed: Dec. 9, 2020

Related U.S. Application Data
(63) Continuation-in-part of application No. 17/074,154, filed on Oct. 19, 2020.
Application No. 17/074,154 is a continuation-in-part of application No. 16/797,995, filed on Feb. 21, 2020.
Application No. 16/797,995 is a continuation of application No. 16/159,056, filed on Oct. 12, 2018, now Pat. No. 10,582,041.
(60) Provisional application No. 62/940,352, filed on Nov. 26, 2019.
(60) Provisional application No. 62/572,267, filed on Oct. 13, 2017.

(51) Int. Cl. H04M 3/22; H04M 1/66; H04M 3/436

(52) U.S. Cl. CPC H04M 3/2281; H04M 1/66; H04M 3/42059; H04M 2203/556; H04M 3/436

(57) ABSTRACT

Calls initiated from disconnected phone numbers and calls initiated to disconnected phone numbers can be indicative of robocalls. Disconnected phone numbers and phone numbers that have initiated calls to disconnected phone numbers are identified and assigned a robocall score that indicates a likelihood that a call initiated from that number is a robocall. Calls that are received from originating numbers with high robocall scores may be acoustically profiled for further confirmation of robocall detection using an acoustic profiler. An acoustic profiler identifies suspicious and potentially fraudulent phone calls by virtue of their audio characteristics.

### CROSS-REFERENCE TO RELATED APPLICATION

The present disclosure claims priority to, and is a continuation-in-part of, U.S. patent application Ser. No. 17/074,154, which claims priority to U.S. Provisional Patent Application No. 62/940,352, filed Nov. 26, 2019, both of which are incorporated herein by reference, and also claims priority to, and is a continuation-in-part of, U.S. patent application Ser. No. 16/797,995, which is a continuation of U.S. patent application Ser. No. 16/159,056, filed Oct. 12, 2018, now U.S. Pat. No. 10,582,041, which is a nonprovisional of and claims priority to U.S. Provisional Patent Application No. 62/572,267, filed Oct. 13, 2018, all of which are incorporated herein by reference.

### BACKGROUND

Receipt of automated calls, also known as robocalls, is an increasing frustration for many phone users. Users can add their phone number to a national do-not-call registry, but many entities that conduct robocalls either don't consult the do-not-call registry or have found other ways around it. In many cases, robocallers hide their identity by spoofing the originating number to make it appear that a phone call is originating from another number, which may not even be associated with the entity making the call. For example, an entity will spoof their originating number to make it appear to a call recipient that a call is originating from a number that is local to the call recipient, regardless of where the call is actually originating from.

### SUMMARY

Implementations described herein provide architecture and techniques for robocall detection using an acoustic profiler. An acoustic profiler identifies suspicious and potentially fraudulent phone calls by virtue of their audio characteristics. Use of an acoustic profiler with incoming phone calls supports authentication of legitimate callers, reduces the potential for fraud, and reduces call handling times, both of which assist service providers and contact centers with authentication of legitimate callers. The acoustic profiler may also help assure that legitimate phone calls are not blocked or misidentified as suspicious.

An acoustic profiler operates based on the fact that a human is incapable of creating the exact same acoustic profile on multiple phone calls. The acoustic profiler distinguishes phone calls originated with a human on the line from those phone calls where the originating party is a recorded message and/or a machine. The acoustic profiler takes into account acoustic properties that can only be duplicated by playing the exact same audio, much like a fingerprint.

Additionally, in example implementations, phone numbers that are known to be disconnected may be identified, analyzed, and assigned a robocall score indicating a likelihood that a phone call initiated from a particular number is potentially from a robocaller. Additionally, phone numbers that initiate calls to disconnected numbers may be identified, analyzed, and assigned a robocall score indicating a likelihood that a call initiated from a particular number is potentially from a robocaller. Phone numbers identified as likely being a robocall may be used as a starting point for identifying robocalls based on acoustic profiling.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram illustrating an example environment in which robocall detection using acoustic profiling may be implemented, in accordance with various implementations.

FIG. 2 is a block diagram illustrating select components of an example computing device implementing a robocall detection service using acoustic profiling, in accordance with various implementations.

FIG. 3 is an example power spectrum for an audio stream of an incoming call.

FIG. 4 is the example power spectrum for the audio stream of the incoming call of FIG. 3 including markers.

FIG. 5 is an example of two power spectrums from a common source where the audio streams have different wording illustrating aligned portions of the two power spectrums that identify the common source.

FIGS. 6 and 7 are flow diagrams of example methods for robocall detection using acoustic profiling, in accordance with various implementations.

### DETAILED DESCRIPTION

### Overview

In example implementations, an acoustic profiler platform may be used to identify robocalls making incoming calls to a communication network. When an incoming phone call is received by a user within a communication network, an acoustic profile call agent may be bridged onto the call. The acoustic fingerprinter may then be used to create an acoustic fingerprint of the entire audio steam created by the incoming caller, which could be a robocaller, or at least a portion of the audio stream created by the incoming caller. The acoustic fingerprinter will then store the acoustic fingerprint created from the incoming caller's audio stream in an acoustic profile data store of the acoustic profiler platform. The acoustic profile data store may consist of acoustic fingerprints as well as other information related to the call, such as the first date and time the call was captured on the call network.

When a subsequent incoming phone call is received by a phone system, e.g., a phone or other electronic device capable of receiving phone calls, an acoustic fingerprint may be created and compared with acoustic fingerprints stored within the acoustic profile data store of the acoustic profiler platform. At the point a match is found, the acoustic profile data store may be updated to indicate that the originating phone number is definitely a robocaller as opposed to having just a particular score or probability of being a potential robocaller. This is due, as previously noted, to the fact that a human is incapable of creating the exact same audio steam on multiple phone calls. The acoustic profiler platform distinguishes phone calls originated by a human caller from phone calls where the originating party is a machine/robocaller, based on the acoustic fingerprint created from the incoming caller during each call. The acoustic profiler platform takes into account acoustic properties that can only be duplicated by playing the exact same audio, much like a fingerprint. In example implementations, additionally or alternatively, a robocall recording data store may store the call recordings of the calls that have been identified by the acoustic profiler platform as being a robocall. Additionally, the phone number associated with the robocall may be stored in a robocall number database. Acoustic profiling is language independent and an audio recording cannot be reverse engineered from any acoustic fingerprint.

The acoustic profiler platform may be integrated into the call flow according to the following example. When an incoming phone call is received at a receiving party's device within a communication network, the acoustic profile call agent is bridged onto the phone call. The acoustic profile call agent activates an acoustic fingerprinter to screen the phone call and create an acoustic fingerprint based on the incoming caller's audio stream during that call. The created acoustic fingerprint is then compared against existing acoustic fingerprints stored in the acoustic profile data store. If a match is found, then it is determined that the call source is a machine, e.g., a robocall. At the point a match is found, the acoustic profile call agent may notify the communication network that a match was detected. The communication network can apply one or more call handling procedures such as, for example, notifying a traceback group to research the source of the call, ending the phone call, and/or providing a warning message to the call recipient. If no match exists, the phone call may be sent on to an agent or to an interactive voice response (IVR) for further processing. The created acoustic fingerprint may be stored for comparison with future created acoustic fingerprints in the acoustic profile data store. The example scenario may be performed at the front end of a phone call, or throughout the duration of the call, without any call participants knowing that this acoustic profiling action is taking place. The acoustic profiler platform may be deployed in a central hosting center, on a user's premises, or as a cloud-based telephony-as-a-service implementation. The acoustic profiler platform may also be used with respect to the creation of acoustic fingerprints from previously recorded calls. For example, acoustic fingerprints may be created using recordings of previously recorded calls that are screened by the acoustic fingerprinter from a batch file as opposed to acoustic fingerprints that are created during a live call. Existing acoustic fingerprints in the acoustic profile data store that have not generated a match over a configurable period of time may be removed or deleted.

When future phone calls are received and matched with an acoustic fingerprint in the acoustic profile data store, a communication network associated with the destination phone number may be notified that a match was detected. The communication network may take an appropriate call handling action such as ending the call or providing a warning message to the phone call recipient.

Robocall detection, as described herein, enables a communication network to identify whether or not a particular call is likely being initiated by a robocaller. In some of the described implementations, data that is gathered in association with disconnected numbers is further analyzed to identify possible robocalls. For example, one or more communication networks may subscribe to a disconnected call intercept service, which may provide an informative message to a caller when the caller places a call to a disconnected number. For example, if a user places a call to a disconnected number that was previously associated with a plumbing business, rather than just notifying the caller that the number is disconnected, the call may be forwarded to an intercept service. The intercept service may then provide a more informative message (e.g., a list of one or more numbers for other plumbing businesses in the area) to the caller.

The intercept service maintains a list of numbers that are known to be disconnected. In an example implementation, the intercept service may receive from one or more communication networks, a list of one or more numbers that the communication networks know to be disconnected. For example, when a company goes out of business or a residential customer moves out of the area or otherwise cancels their service, those numbers may be added to a list that is sent to the intercept service. Alternatively, or in addition, the intercept service may identify a number as a disconnected number when the intercept service receives a call directed to the number, e.g., the receiving phone number. For example, a communication network may not provide a list of disconnected numbers to the intercept service, but instead, may just forward to the intercept service any received calls that are directed to disconnected numbers. In either case, the intercept service may maintain a data store of disconnected numbers. The intercept service may be available to multiple communication networks, and thus, the data store of disconnected numbers may include disconnected numbers that are associated with multiple communication networks.

The disconnected number data store may maintain or store additional data associated with one or more disconnected numbers. For example, there may be numbers that are temporarily disconnected, e.g., due to customer request or technical problems with the networks. Numbers that are known to be only temporarily disconnected may be stored in the disconnected number data store with a flag or other indication that the number is only temporarily disconnected.

The disconnected number data store may be updated periodically. Updates may occur in various ways. For example, a communication network may periodically provide updated data to the intercept service identifying, for example, newly disconnected numbers and/or previously disconnected numbers that have been put back in service. In alternate implementations, the disconnected number data store may be updated in other ways, for example, based on how recently a call directed to the disconnected number has been received by the intercept service or how long the number has been flagged as a disconnected number. For example, numbers that have been disconnected may be reused (reassigned to another user) after a few months of being disconnected. If the intercept service has recently received a call directed to a particular number, that number can be assumed to still be a disconnected number.

In an example implementation, when the intercept service receives a call, if the destination number is not already in the disconnected number data store, the destination number associated with the call is added to the disconnected number data store. In addition, the data store may record the number and the date that the call was received. The date represents the last time at which the number was known to be disconnected. The data store may also include a record of how many calls to the number have been intercepted, and may, in some instances, record a date of each intercepted call that is received.

An example robocall detection service accesses the disconnected number data store to identify phone numbers that are known to be disconnected. Because these phone numbers are known to be disconnected, no outgoing calls should be initiated from these numbers. Accordingly, a communication network subscribed to the robocall detection service may send data to the robocall detection service when a call is placed or received. The robocall detection service compares an originating number associated with the phone call to the disconnected number data store. If an originating number associated with a phone call is a known disconnected number, then the robocall detection service notifies the communication network that there is a high likelihood that the phone call is a robocall. The communication network can then handle the call according to rules or guidelines in place at the communication network related to handling of robocalls.

The intercept service may also identify originating phone numbers that initiate a large number of calls to disconnected numbers. Because robocallers frequently generate calls randomly, robocallers are more likely than legitimate callers to place a large number of calls to disconnected numbers. Accordingly, in an example implementation, the intercept service may store data that identifies originating phone numbers that place calls to disconnected numbers. This data is also accessible to the robocall detection service. In an example, when an originating phone number repeatedly places a number of calls to one or more disconnected numbers over time, that originating phone number may be flagged as likely being associated with a robocaller.

Because robocallers have the ability to spoof their originating number, there is a degree of uncertainty in flagging a particular originating number as a robocaller. In other words, a robocaller may spoof their originating number as a legitimate number. In this scenario, flagging that legitimate number as a robocaller could negatively impact the legitimate subscriber to whom that number is subscribed. In an example implementation, each number that is identified in the disconnected number data store may have an associated score that indicates a likelihood that the number is a robocaller. Phone numbers that are known to be disconnected numbers may have a high score indicating a high likelihood that any phone call originating from that number is from a robocall, while numbers that have been identified as placing a threshold number of calls to disconnected numbers may have a lower score indicating a lower likelihood that any phone call originating from that number is from a robocall.

In an example implementation, the robocall detection service receives data associated with disconnected numbers and originating numbers that have placed calls to disconnected numbers. The data is received from the intercept service, which gathers data from multiple communication networks. The robocall detection service analyzes the received data to calculate a robocall score that indicates a likelihood that a call originating from a particular number is a robocall. Various factors, such as frequency of calls made or received, time of day at which calls are made, how recently calls have been made, how long a number has been disconnected, etc., may be considered in analyzing the data to generate the robocall scores. For example, a disconnected number that has placed multiple calls within the past hour may have a higher score than a disconnected number that last placed a call more than 24 hours earlier. As another example, a number that has placed one or more calls to a single disconnected number may be assigned a lower score than a number that has placed calls to multiple disconnected numbers. (For example, a disconnected number that was previously assigned to a fax machine may continue to receive calls from originating numbers that are trying to send a fax. Multiple calls to that disconnected number from a single originating number may not necessarily indicate that the originating number is a robocaller.) Also, a number that has placed only three calls to disconnected numbers within the past two hours may be assigned a lower score than a number that has placed 10 or more calls to disconnected numbers within the past two hours. Time of day may also be a factor in calculating a robocall score in that robocallers typically don't place calls in the middle of the night.

As described above, the intercept service aggregates data associated with disconnected numbers from multiple communication networks. This data is then provided to the robocall detection service. In implementations, the robocall detection service generates robocall scores for numbers that are associated with multiple communication networks. Thus, the robocall detection service provides a more comprehensive service than one implemented for only a single communication network. Furthermore, communication networks that are subscribed to the robocall detection service do not have to be subscribed to the intercept service.

In example implementations, the acoustic profiler may be used to identify robocalls. When a phone call from a suspected robocaller is directed to a phone number that is not in service, e.g., the phone number is disconnected, the phone call may be intercepted by the intercept service and handled along two paths. The first path may involve playing an outgoing message, e.g., “this number is not in service.” The robocall detection service may compare an originating number associated with the phone call to phone numbers in robocall number data store. If the originating number associated with the phone call is found in the robocall number data store (thereby indicating that the originating number is a robocaller), the second path may involve the robocall detection service listening in to the call as the robocaller begins communicating, e.g., playing a pre-recorded message. This occurs because the robocaller does not respond to the outgoing message but knows the robocall has been answered and thus begins playing its own pre-recorded message. The robocall detection service may record the entire pre-recorded message, or at least a portion of the pre-recorded message, and then store the pre-recorded message in a robocall recording data store. The acoustic profiler may create an acoustic fingerprint of the recording and store the acoustic fingerprint in an acoustic profile data store.

When a subsequent phone call to a phone number that is not in service is intercepted, an acoustic fingerprint may be created and compared with acoustic fingerprints stored within the acoustic profile data store. At the point a match is found, the robocall number data store may be updated to indicate that the originating phone number is definitely a robocaller as opposed to having just a particular score or probability. This is due, as previously noted, to the fact that a human is incapable of creating the exact same acoustic fingerprint on multiple phone calls. The acoustic profiler distinguishes phone calls originated with a human on the line from those phone calls where the originating party is a pre-recorded message and/or a machine based on the acoustic fingerprint of the pre-recorded message and/or the audio produced by the machine. The acoustic profiler takes into account acoustic properties that can only be duplicated by playing the exact same audio, much like a fingerprint. Acoustic fingerprinting is language independent and an audio recording cannot be reverse engineered from an acoustic fingerprint.

The acoustic profiler may be integrated into the call flow according to the following example transaction. When a phone call is received at a receiving party's device within a user communication network, an acoustic profile call agent is bridged onto the phone call. The call agent activates an acoustic fingerprinter to listen in to the phone call and create an acoustic fingerprint for that call. The created acoustic fingerprint is then compared against existing acoustic fingerprints stored in the acoustic profile data store. If a match is found, then it is determined that the call source is a machine, e.g., a robocall. At the point a match is found, the call agent notifies the user communication network that a match was detected. The communication network can take the appropriate action such as ending the phone call or providing a warning message to the call recipient. If no match exists, the phone call may be sent on to an agent or to an interactive voice response (IVR) for further processing. The created acoustic fingerprint may be stored for comparison with future created acoustic fingerprints. The example transaction may take between 1-2 seconds and may be performed at the front end of a phone call without a real caller knowing that this action is taking place. The acoustic profiler may be deployed in a central hosting center, on a user's premises, or as a cloud-based telephony-as-a-service implementation. The acoustic profiler may be used with respect to previous calls. For example, acoustic fingerprints may be created using recordings of previous calls made by machines. Existing acoustic fingerprints in the acoustic profile data store that have not generated a match over a configurable period of time may be removed from the acoustic profile data store.

In accordance with example implementations, the robocall detection techniques described herein may be used to prevent flooding of call centers. When robocalls are placed in heavy volume to a call center to prevent the call center from properly functioning, e.g., paralyzing the call center, the robocall detection techniques may be used to identify the robocalls and prevent them from reaching agents at the call center thereby keeping the agents available for legitimate phone calls to the call center. Even if a robocall makes it to an agent, the phone call may be terminated upon identifying the call as a robocall.

When future phone calls from the originating phone number are intercepted and matched with the robocall number data store, a communication network associated with the destination phone number may be notified that a match was detected. The communication network may take an appropriate action such as ending the call or providing a warning message to the phone call recipient.

### Illustrative Environment

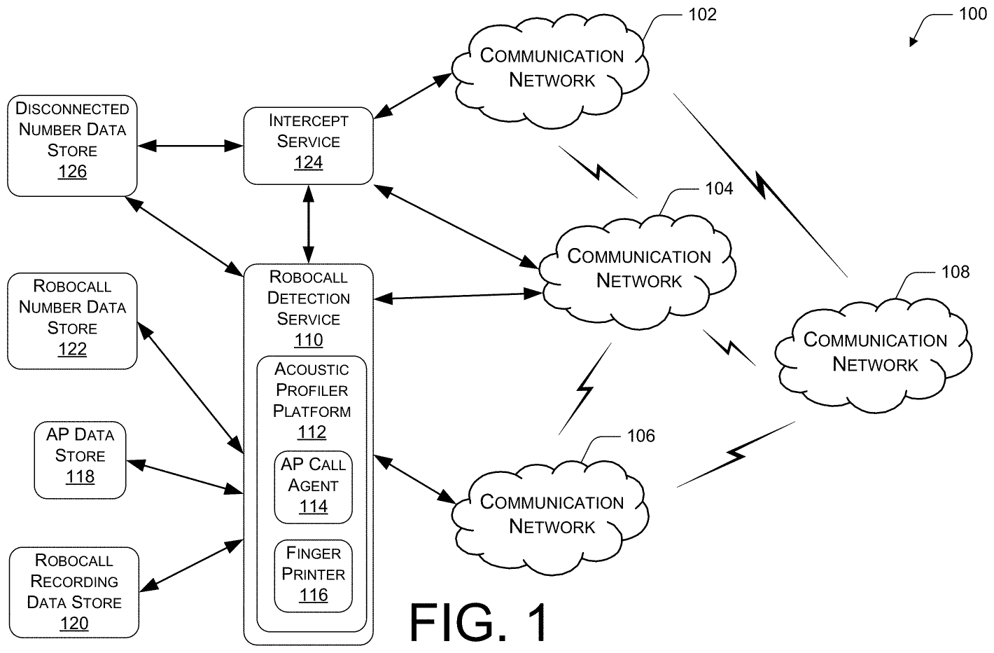

FIG. 1 illustrates an example environment 100 in which robocall detection using an acoustic profiler platform 112 may be implemented. Example environment 100 includes one or more communication networks. In the illustrated example, communication networks 102, 104, 106, and 108 are each able to communicate with the others. Communication networks 102, 104, 106, and 108 represent wired telephone networks, wireless telephone networks, and IP networks that support Voice over Internet Protocol (VoIP). Each communication network may represent a different telephone carrier.

Example environment 100 also includes a robocall detection service 110 that includes an acoustic profiler platform 112. In some configurations, the acoustic profiler platform 112 is configured and operates as a stand-alone robocall detection platform. Additionally, or alternatively, the acoustic profiler platform 112 may be configured to operate in conjunction with other components of the robocall detection service 110. Any number of communication networks 102, 104, and 106 may subscribe to robocall detection service 110 or may use the acoustic profiler platform 112. In the illustrated example environment 100, communication network 102, communication network 104, and communication network 106 subscribe to robocall detection service 110 or may use the acoustic profiler platform 112 outside of the robocall detection service 110.

In implementations, the acoustic profiler platform 112 may include an acoustic profile (AP) call agent 114 that serves as an interface to a phone system, e.g., a phone or other electronic device configured to receive phone calls via communication networks 102, 104, and/or 106. An acoustic fingerprinter 116 screens the audio stream from the originating party, e.g., the calling party, and creates an acoustic fingerprint, in real-time based on that audio stream. An acoustic profile (AP) data store 118 may be included within the acoustic profiler platform 112 or may be separate. The AP data store 118 is a library that stores previously created acoustic fingerprints of phone calls and it may also store additional information about the call such as the date and time the call first appeared on the call network.

The acoustic profiler platform 112 (or some other part of the robocall detection service 110) may also record the entire phone call, or at least a portion of the phone call, simultaneously, the acoustic fingerprinter 116 may create an acoustic fingerprint of the call and store it in the AP data store 118. If the acoustic profiler platform 112 finds a match between the acoustic fingerprint created from the audio stream on the current call and an acoustic fingerprint already in the AP data store 118, then the acoustic profiler platform 112 may also store at least a portion of the recording of the call or the entire recording of the call in the robocall recording data store 120 and store and flag the phone number in the robocall number data store 122. In example implementations, additionally or alternatively, a robocall recording data store 120 may store all call recordings where the originating phone number was determined to be a robocall by the acoustic profiler platform 112 (with or without corresponding acoustic profiles). In example implementations, the robocall recording data store 120 may be part of the acoustic profile data store 118. A robocall number data store 122 may be included for storing known and/or suspected phone numbers associated with robocallers based on the results from the acoustic profiler platform 112. In implementations, one or more of the AP data store 118, the robocall recording data store 120, and/or the robocall number store 122 may be implemented in a single data store.

Thus, in implementations, the acoustic profiler platform 112 uses a complex algorithm that screens live phone calls to create a unique acoustic fingerprint representing the entire audio stream or sound profile of the originating caller, or at least a portion thereof. As will be discussed further herein, each acoustic fingerprint contains a number of hashes created during a specific call. Hashes are any two frequency points and the distance in time between them. Once the acoustic fingerprint is created for each call, the acoustic fingerprint may be screened against and stored in the acoustic profile data store 118. The acoustic profiler platform 112 may thus identify matches between live acoustic fingerprints created from calls and previously created and stored acoustic fingerprints in the acoustic profile data store 118 in real time. Whereas humans are unable to produce the exact same sound profile more than once, machine-generated calls/robocalls generally produce identical sound profiles an indefinite number of times. Upon identifying a match as between acoustic fingerprints, the acoustic profiler platform 112 may store a recording of the call in the robocall recording data store 120 for future review and may alert one or more of the communication networks 102, 104, and/or 106 in real time, allowing the communication networks to take appropriate action with regard to the call. In configurations, the call may be recorded from the beginning of the call and once a match is made with acoustic fingerprint in the AP data store 118, the recording of the call is then stored in the robocall recording data store 120 as a known robocall. Additionally, the originating phone number may be stored in the robocall number data store 122 as a known robocall number.

Example environment 100 also includes intercept service 124. Any number of communication networks may subscribe to intercept service 124 and/or robocall detection service 110. In the illustrated example environment 100, communication network 102 and communication network 104 subscribe to intercept service 124, and communication network 104 and communication network 106 subscribe to robocall detection service 110. In the illustrated example environment 100, communication network 108 is not subscribed to either intercept service 124 or robocall detection service 110.

Intercept service 124 is implemented to handle calls directed to disconnected numbers. For example, when communication network 102 receives a call that has a destination number that is a disconnected number, the communication network 102 forwards the call to intercept service 124. Intercept service 124 handles the call according to predefined call handling preferences. For example, if the call is directed to a number that was previously associated with a business, intercept service 124 may provide a message to the caller with alternate numbers for similar businesses in the area. As another example, if the call is directed to a number that is temporarily disconnected, the intercept service 124 may provide a message to the caller indicating when the number is expected to be reconnected. In implementations, intercept service 124 maintains disconnected number data store 126, which stores records associated with numbers that are, or have been, disconnected. Disconnected number data store 126 aggregates disconnected number data from each communication network that is subscribed to the intercept service 124, which in the illustrated example environment 100 includes communication networks 102 and 104.

As previously noted, the robocall detection service 110 is implemented to identify phone numbers that are suspected of being associated with robocallers. In the illustrated example implementation of FIG. 1, robocall detection service 110 maintains robocall number data store 122. Robocall detection service 110 obtains data, at least in part, from disconnected number data store 126 that is maintained in association with intercept service 124. For example, robocall detection service 110 may receive a list of disconnected numbers from disconnected number data store 126, which includes data generated from communication network 102 and communication network 104. In an example implementation, intercept service 124 or disconnected number data store 126 may also be configured to provide to robocall detection service 110 originating numbers that have initiated calls to disconnected numbers.

In implementations, the acoustic fingerprinter 116 listens to the originating party, e.g., the calling party, and creates an acoustic profile, in real-time, for a phone call that is in progress. As previously noted, the acoustic profile data store 118 is a library that stores previously created suspicious acoustic profiles of phone calls and acoustic profiles of known robocallers. The acoustic profiler platform 112 (or some other part of the robocall detection service 110) may record the entire phone call, which is generally a pre-recorded message, or at least a portion of the phone call, and then store the recorded phone call in the robocall recording data store 120. In example implementations, the robocall recording data store 126 may be part of the robocall number data store 122.

The example environment 100 illustrated in FIG. 1 is merely one example implementation environment. Other environments are also considered. For example, robocall detection service 110 may be implemented in an environment that does not include intercept service 124. In such an implementation, robocall detection service 110 may receive data identifying disconnected numbers and/or numbers that have placed calls to disconnected numbers from other sources, such as, for example, directly from one or more communication networks, e.g., communication networks 102, 104, 106, and/or 108. As another example, the intercept service 124 and the robocall detection service 110 may be implemented as a single service that performs the functions of the intercept service and the robocall detection service 110 as described herein. As a further example, robocall detection service 110 may be implemented as a component of, or in association with, a single communication network, providing robocall detection based on disconnected number data to only that single communication network. Also, one or more of the disconnected number data store 126, robocall call number data store 122, robocall recording data store 120, and/or acoustic profile data store 118 may be part of a single data store.

In various implementations, robocall detection service 110 may receive data identifying disconnected numbers and/or numbers that have placed calls to disconnected numbers from any number of sources, which may be a single source or any number of distributed sources. Similarly, robocall detection service 110 may be implemented to provide robocall detection data to any number of entities, including, for example, one or more specific communication networks.

### Example Computing Device

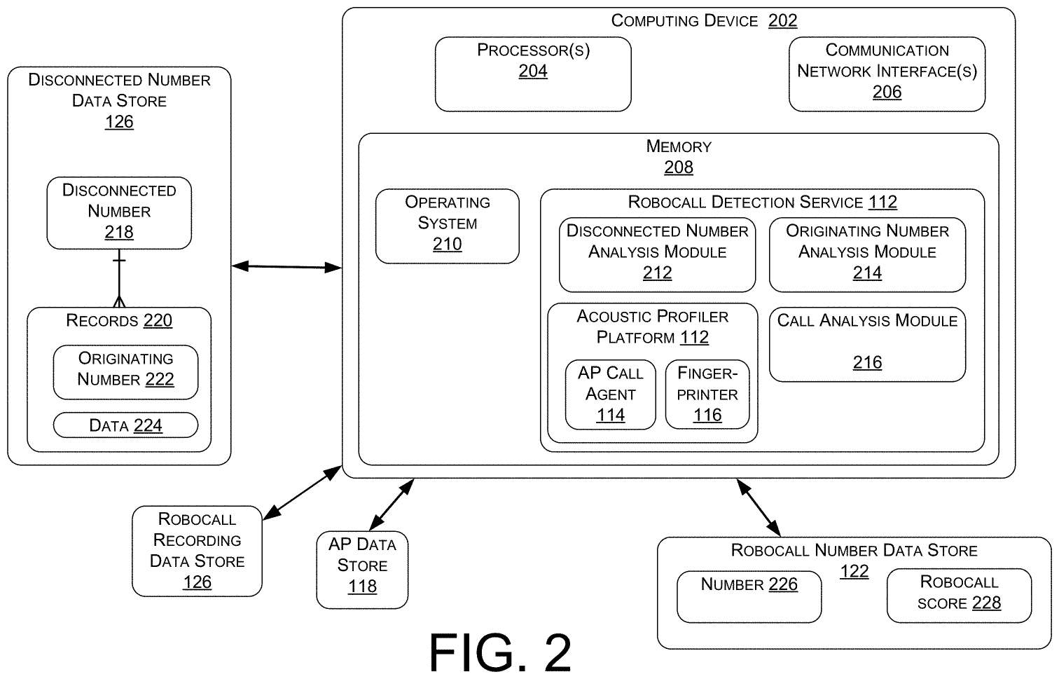

FIG. 2 illustrates select components of an example computing device 202 implementing robocall detection service 110. Robocall detection service 110 may be implemented on a single computing device or may be distributed across multiple computing devices. Accordingly, example computing device 202 represents one or more computing devices over which robocall detection service 110 may be implemented.

Example computing device 202 includes one or more processors 204, one or more communication network interfaces 206, and memory 208. Processor(s) 204 can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc.

Communication network interface(s) 206 are configured to enable communications between computing device 202 and any number of communication networks.

Memory 208 is implemented as computer-readable media configured to store instructions executable by the processor 204. Memory 208 may include computer storage media and/or communication media. Computer storage media can include volatile memory, nonvolatile memory, and/or other persistent and/or auxiliary computer storage media, removable and non-removable computer storage media implemented in any method or technology for storage of information such as computer-readable instructions, data structures, program modules, or other data. Memory 208 is an example of computer storage media. Thus, the memory 208 includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Executable instructions stored on memory 208 can include, for example, an operating system 210, robocall detection service 110, and any number of other modules, programs, or applications that are loadable and executable by processor 204.

Robocall detection service 110 includes disconnected number analysis module 212, originating number analysis module 214, call analysis module 216, and acoustic profiler platform 112. Disconnected number analysis module 212 is configured to receive and analyze data associated with disconnected phone numbers. For example, disconnected number data store 126 may be implemented to include one or more disconnected numbers 218. In various implementations, additional data may also be maintained in association with the disconnected numbers 218 (e.g., a flag indicating that the number is only temporarily disconnected). In the illustrated example, for each disconnected number 218, disconnected number data store 126 also stores any number of associated records 220 identifying an originating number 222 that initiated a call to the disconnected numbers 218 and data 224 such as, for example, a date/time of the call.

In implementations, robocall detection service 110 receives data 224 from disconnected number data store 126, analyzes the data, and for one or more numbers 226, calculates a robocall score 228 that indicates a likelihood that a call originating from a particular number 226 is a robocall. For example, numbers 226 that are known to be disconnected will likely have a high robocall score 228 because disconnected numbers should not be making any calls.

Originating number analysis module 214 is configured to receive data identifying originating numbers that have placed calls to disconnected numbers. For example, data 224 from records 220 may be received from disconnected number data store 126. In implementations, originating number analysis module 214 may be configured to analyze the received data 224 and generate, for each originating number, a robocall score 228 that represents a likelihood that a call initiated by such an originating number is a robocall. Various factors may be considered in generating a robocall score 228 for such originating numbers that have placed calls to disconnected numbers, e.g., disconnected numbers 218. The various factors that may be included within the data 224 may include, for example, a number of distinct disconnected numbers to which calls have been placed, a frequency with which calls to such disconnected numbers have been made, times of day at which calls to disconnected numbers have been made, etc.

Call analysis module 216 is configured to receive, from a communication network, e.g., communication network 102, 104, 106, and/or 108 subscribed to robocall detection service 112, an originating number associated with a call. Call analysis module 216 may then correlate the originating number with a number 226 by querying the robocall number data store 122 for the originating number. If the originating number is stored in the robocall number data store 122 as a number 226, call analysis module 216 may then return to the communication network an indication of the robocall score 228 associated with the originating number in robocall number data store 122 based upon the corresponding number 226 in the robocall number data store 122. The communication network may then handle the call based on the received robocall score 228. For example, if an originating number has a high robocall score 228, the call may be terminated, if the originating number has a low robocall score 228, the call may be allowed to continue, and if the originating number has an intermediate robocall score 228, the call may be sent directly to voicemail. Any number of call handling procedures may be implemented by a communication network based, at least in part, on the provided robocall score 228.

In implementations, the acoustic profiler platform 112 may be configured to create acoustic profiles for originating phone calls that are intercepted by the intercept service 124 of FIG. 1. For example, when a phone call from a suspected robocaller is directed to a phone number that is not in service, e.g., the phone number is disconnected, the phone call may be intercepted by the intercept service 124 of FIG. 1 and handled along two paths. The first path may involve playing an outgoing message, e.g., “this number is not in service.” The robocall detection service 110 may compare an originating number associated with the phone call to phone numbers in the disconnected number data store 126. If the originating number associated with the phone call is found in the disconnected number data store 126, e.g., originating numbers 222 of records 220 (thereby indicating that the originating number is a robocaller), the second path may involve the acoustic profiler platform 112 listening in to the phone call via the AP call agent 114 of FIG. 1 as the robocaller begins communicating, e.g., playing a pre-recorded message. This occurs because the robocaller does not respond to the outgoing message but knows the robocall has been answered and thus begins playing its own pre-recorded message. An acoustic profile may be created and stored in the AP data store 118 along with an acoustic fingerprint created by the acoustic fingerprinter 116. The number 226 associated with the call may be labelled as being associated with a known robocaller in the robocall number data store 122. Any scores 228 associated with the number 226 may be discarded. The acoustic fingerprinter 116, or some other component of the acoustic profiler platform 112 or robocall detection service 110, may record the entire pre-recorded message, or at least a portion of the pre-recorded message, and then store the pre-recorded message in the robocall recording data store 120.

Accordingly, when a subsequent phone call to a phone number that is not in service is intercepted, an acoustic fingerprint may be created by the acoustic profiler platform 112 and compared with acoustic fingerprints stored within the AP data store 118. At the point a match is found, the robocall number data store 122 may be updated to indicate that the originating phone number 226 is definitely a robocaller as opposed to having just a particular robocall score 228 or probability. This is due, as previously noted, to the fact that a human is incapable of creating the exact same acoustic fingerprint on multiple phone calls. The acoustic profiler platform 112 distinguishes phone calls originated with a human on the line from those phone calls where the originating party is a pre-recorded message and/or a machine based on the acoustic fingerprint of the pre-recorded message and/or the audio produced by the machine. The acoustic profiler platform 112 takes into account acoustic properties that can only be duplicated by playing the exact same audio, much like a fingerprint. If no match is made and the originating number 226 has a high score 228 as a likely robocaller, the created acoustic fingerprint and recorded phone call may be stored in the AP data store 118 and/or the robocall recording data store 120 for comparison with future acoustic fingerprints and/or recorded phone calls created from subsequent phone calls originating from suspicious numbers 226 having a high robocall score 228

Thus, the acoustic profiler platform 112 is configured to create acoustic fingerprints for phone calls or other audio streams. For example, when a phone call is received, the AP call agent 114 may be bridged onto the call to screen the call. When the caller begins communicating, the acoustic fingerprinter 116 may then be used to create an acoustic fingerprint to compare against existing acoustic fingerprints in the AP data store 118. The acoustic profiler platform 112 or robocall detection service 110, may also record the entire call, or at least a portion of the call, and then store the recording of the call in the robocall recording data store 120.

In some configurations, the acoustic profiler platform 112 may also be used with respect to the creation of acoustic fingerprints from previously recorded calls. For example, acoustic fingerprints may be created using recordings of previously recorded calls are screened by the acoustic fingerprinter 116 from a batch file that may be received from a third party as opposed to acoustic fingerprints that are created during a live call. The acoustic fingerprints created using recordings of previously recorded calls may be stored in the AP data store 118. Existing acoustic fingerprints in the AP data store 118 that have not generated a match over a configurable period of time may be removed or deleted.

When a subsequent phone call is received, an acoustic fingerprint may be created by the acoustic profiler platform 112, e.g., the acoustic fingerprinter 116, and compared with acoustic fingerprints stored within the AP data store 118. At the point a match is found, the robocall number data store 122 may also be updated to indicate that the originating phone number 212 is definitely associated with a robocaller. The recording of the phone call may be stored in the robocall recording data store 120 and the fingerprint in the AP data store 118 may also be flagged as an acoustic fingerprint known to be from a robocaller. The match is due, as previously noted, to the fact that a human is incapable of creating the exact same acoustic profile on multiple phone calls. The acoustic profiler platform 112 distinguishes phone calls originated with a human on the line from those phone calls where the originating party is a machine/robocaller. The acoustic profiler platform 112 takes into account acoustic properties that can only be duplicated by playing the exact same audio, much like a fingerprint. Also, in implementations, at the point a match is found, the AP call agent 114 may notify one or more of the communication networks 102, 104, and/or 106 that a match was detected. The appropriate communication network can take the appropriate call handling action such as, ending the phone call and/or providing a warning message to the call recipient. If no match is made, the newly created acoustic fingerprint may be stored in the AP data store 118 for comparison with future acoustic fingerprints created from subsequent phone calls. In implementations, one or more of the AP data store 118, the robocall recording data store 120, and/or the robocall number store 122 may be implemented in the memory 208. Additionally, as previously noted, in implementations, one or more of the acoustic profile data store 118, the robocall recording data store 120, and/or the robocall number store 122 may be implemented in a single data store.

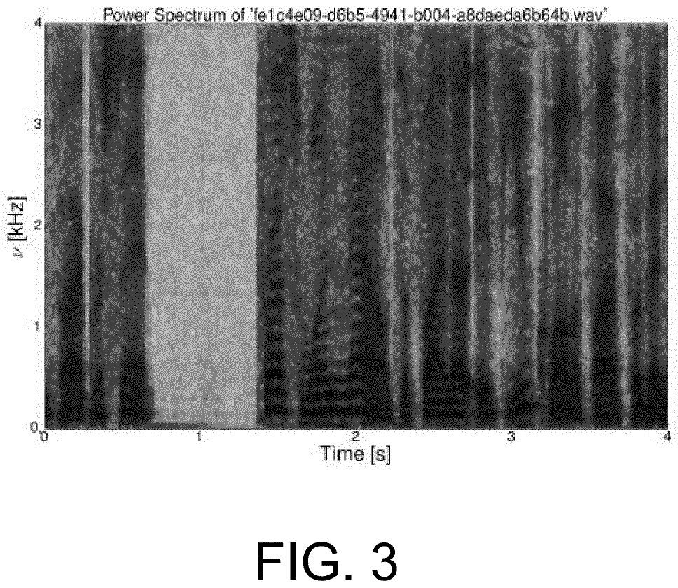

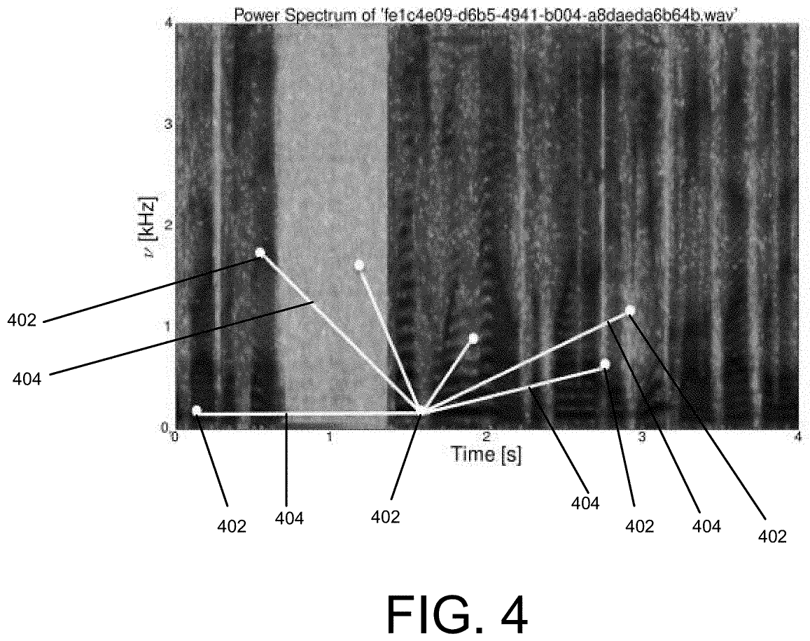

In particular, the acoustic fingerprinter 116 captures data related to the audio streams produced by originating callers. A power spectrum 300 may be created for each audio stream, as may be seen in FIG. 3. Referring to FIG. 4, markers 402 within the data may be analyzed, e.g., a distance between markers 402 may be analyzed, to identify the audio streams as being from a machine. Thus, each acoustic fingerprint contains a number of markers 402 created during a specific call. In configurations, the signals of the audio streams are transformed from time domain to frequency. Accordingly, the markers 402 within the power spectrum are noted and the distance 404 between markers 402 are stored in the acoustic fingerprint for use in identifying the audio stream as originating from a machine. As previously noted, hashes are any two frequency points, e.g., markers 402, and the distance in time between the markers 402.

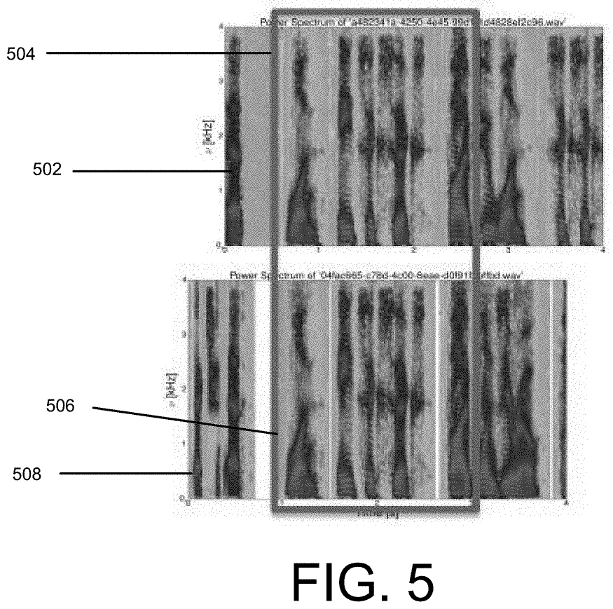

As can be seen in FIG. 5, even if the wording in a robocall is changed, the power spectrum 502 of an audio stream with the new wording still has one or more portions 504 that align with one or more portions 506 of the power spectrum 508 of the original audio stream based on the original wording. Thus, the newly worded machine generated call may still be identified as coming from a known robocall, e.g., the two audio streams come from the same machine.

### Example Method for Robocall Detection

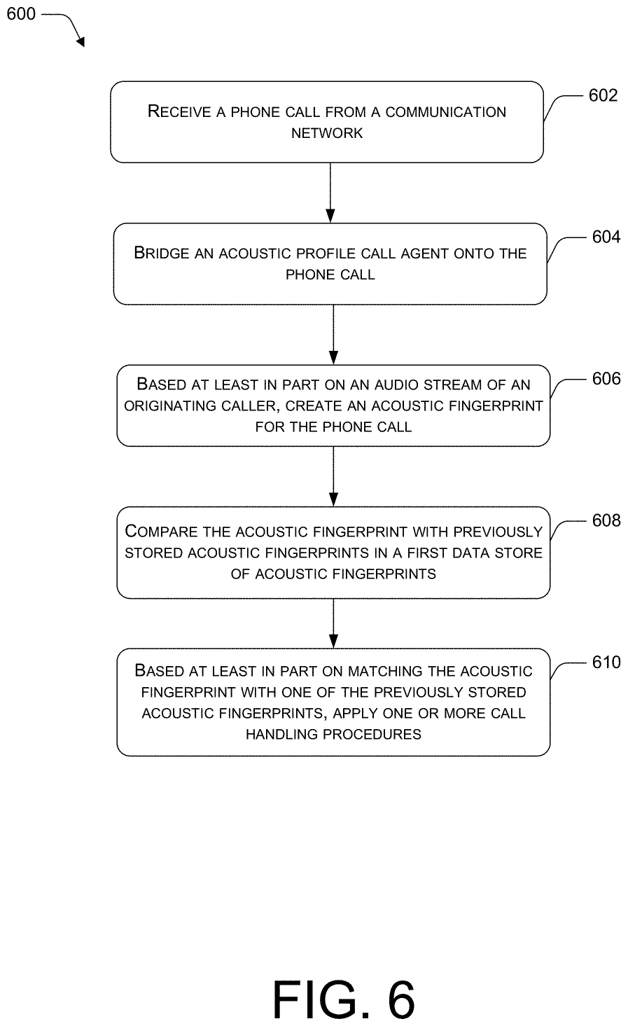

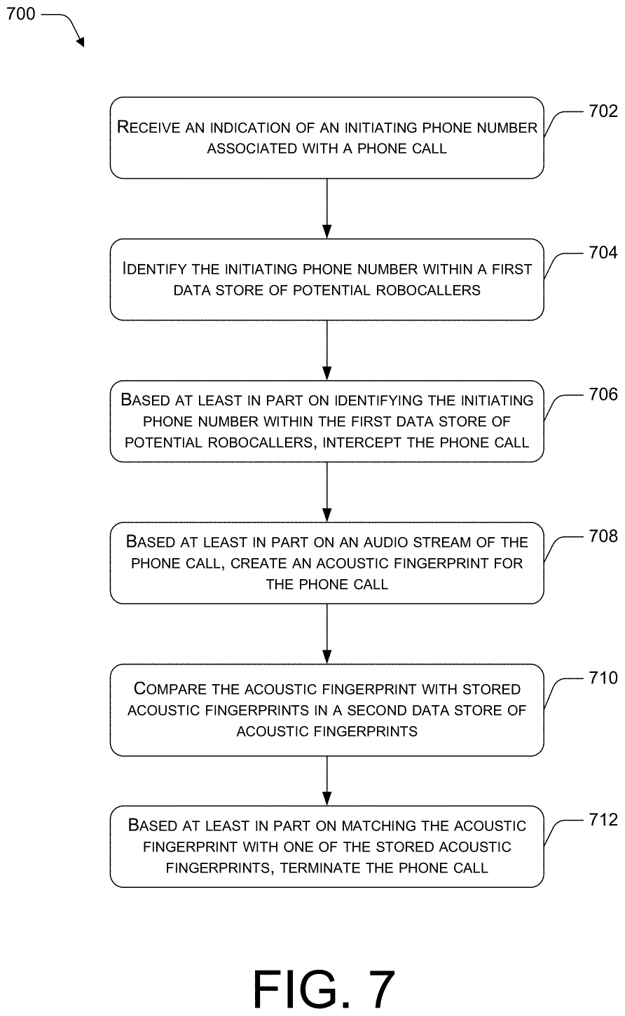

FIGS. 6 and 7 illustrates example methods performed by the robocall detection service 110. The example processes are illustrated as a collection of blocks in a logical flow graph, which represents a sequence of operations that can be implemented in hardware, software, or a combination thereof. The blocks are referenced by numbers. In the context of software, the blocks represent computer-executable instructions stored on one or more computer-readable media that, when executed by one or more processing units (such as hardware microprocessors), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

FIG. 6 illustrates an example method 600 for robocall detection using acoustic profiling.

At block 602, a phone call is received from a communication network. For example, an indication of an originating call, e.g., originating number 212, associated with a phone call may be received from one of the communication networks 102, 104, 106, or 108.

At block 604, an acoustic profile call agent may be bridged onto the phone call. For example, the AP agent 114 may bridge onto the phone call.

At block 606, based at least in part on an audio stream of an originating caller, an acoustic fingerprint for the phone call may be created. For example, the acoustic profiler platform 112 of the robocall detection service 110 may create an acoustic fingerprint using the acoustic fingerprinter 116.

At block 608, the acoustic fingerprint may be compared with previously stored acoustic fingerprints in a first data store of acoustic fingerprints. For example, the acoustic profiler platform 112 may compare the created acoustic fingerprint with acoustic fingerprints stored in the AP data store 118.

At block 610, based at least in part on matching the acoustic fingerprint with one of the previously stored acoustic fingerprints, one or more call handling procedures may be applied. For example, the AP call agent 114 may notify the communication network to process the call according to the proper call handling procedures.

FIG. 7 illustrates an example method 700 for robocall detection using acoustic profiling.

At block 702, an indication of an initiating phone number associated with a phone call is received. For example, an indication of an initiating phone number associated with a phone call may be received from one of the communication networks 102, 104, 106, or 108.

At block 704, the initiating phone number may be identified within a first data store of potential robocallers. For example, the initiating phone number may be identified within the robocall number data store 122.

At block 706, based at least in part on identifying the initiating phone number within the first data store of potential robocallers, the phone call may be intercepted. For example, the intercept service 124 may intercept the phone call.

At block 708, based at least in part on an audio stream of the phone call, an acoustic fingerprint for the phone call may be created. For example, the acoustic profile agent 114 may bridge into the intercepted phone call. The acoustic fingerprinter 122 may create an acoustic fingerprint.

At block 710, the acoustic fingerprint may be compared with stored acoustic fingerprints in a second data store of acoustic fingerprints. For example, the robocall detection service 110 may compare the created acoustic fingerprint with acoustic fingerprints stored in the AP data store 118.

At block 712, based at least in part on matching the acoustic fingerprint with one of the stored acoustic fingerprints, one or more call handling procedures may be applied.

### CONCLUSION

Although the techniques have been described in language specific to structural features and/or methodological acts, it is to be understood that the appended claims are not necessarily limited to the features or acts described. Rather, the features and acts are described as example implementations of such techniques.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method comprising:
receiving, from a communication network, an indication of an initiating phone number associated with a phone call;
identifying the initiating phone number within a first data store of potential robocallers;
based at least in part on identifying the initiating phone number within the first data store of potential robocallers, intercepting the phone call;
based at least in part on an audio stream of the phone call, creating an acoustic fingerprint for the phone call;
comparing the acoustic fingerprint with stored acoustic fingerprints in a second data store of acoustic fingerprints; and
based at least in part on matching the acoustic fingerprint with one of the stored acoustic fingerprints, applying one or more call handling procedures.

2. The method of claim 1, further comprising:
based at least in part on not matching the acoustic fingerprint with one of the stored acoustic fingerprints, storing the acoustic fingerprint in the second data store.

3. The method of claim 1, wherein the first data store of potential robocallers comprises a data store of disconnected phone numbers.

4. The method of claim 3, wherein each disconnected phone number includes a robocall score that represents a likelihood that a phone call originating from the disconnected phone number is a robocall.

5. The method of claim 1, further comprising:
while creating the acoustic fingerprint for the phone call, playing an outgoing recorded message to the initiating phone number.

6. The method of claim 1, wherein the initiating phone number is a disconnected phone number.

7. The method of claim 1, wherein a receiving phone number associated with the phone call is a disconnected phone number.

8. The method of claim 1, further comprising:
recording the entire phone call; and
storing a recording of the entire phone call within a third data store.

9. A method comprising:
intercepting a phone call;
based at least in part on an audio stream of the phone call, creating an acoustic fingerprint for the phone call;
comparing the acoustic fingerprint with stored acoustic fingerprints in a first data store of acoustic fingerprints; and
based at least in part on matching the acoustic fingerprint with one of the stored acoustic fingerprints, applying one or more call handling procedures.

10. The method of claim 9, wherein intercepting the phone call comprises only intercepting the phone call based at least in part on identifying an initiating phone number associated with the phone call is stored within a second data store of potential robocallers.

11. The method of claim 10, wherein the second data store of potential robocallers comprises a data store of disconnected phone numbers.

12. The method of claim 11, wherein each disconnected phone number includes a robocall score that represents a likelihood that a phone call originating from the disconnected phone number is a robocall.

13. The method of claim 9, further comprising:
based at least in part on not matching the acoustic fingerprint with one of the stored acoustic fingerprints, storing the acoustic fingerprint in the first data store.

14. The method of claim 9, further comprising:
while creating the acoustic fingerprint for the phone call, playing an outgoing recorded message to an initiating phone number associated with the phone call.

15. The method of claim 9, wherein an initiating phone number associated with the phone call is a disconnected phone number.

16. The method of claim 9, wherein:
a receiving phone number associated with the phone call is a disconnected phone number; and
intercepting the phone call comprises intercepting the phone call based at least in part on the receiving phone number being a disconnected phone number stored within a data store of disconnected phone numbers.

17. The method of claim 9, further comprising:
recording the entire phone call; and
storing a recording of the entire phone call within a second data store.

18. A system comprising:
one or more processors; and
one or more non-transitory storage media comprising instructions stored thereon, the instructions being executable by the one or more processors to cause the processors to perform one or more actions comprising:
intercepting a phone call;
based at least in part on an audio stream of the phone call, creating an acoustic fingerprint for the phone call;
comparing the acoustic fingerprint with stored acoustic fingerprints in a first data store of acoustic fingerprints; and
based at least in part on matching the acoustic fingerprint with one of the stored acoustic fingerprints, applying one or more call handling procedures.

19. The system of claim 18, wherein intercepting the phone call comprises only intercepting the phone call based at least in part on identifying an initiating phone number associated with the phone call is stored within a second data store of potential robocallers.

20. The system of claim 19, wherein the second data store of potential robocallers comprises a data store of disconnected phone numbers.

21. The system of claim 20, wherein each disconnected phone number includes a robocall score that represents a likelihood that a phone call originating from the disconnected phone number is a robocall.

22. The system of claim 18, wherein the actions further comprise:
based at least in part on not matching the acoustic fingerprint with one of the stored acoustic fingerprints, storing the acoustic fingerprint in the first data store.

23. The system of claim 18, wherein the actions further comprise:
while creating the acoustic fingerprint for the phone call, playing an outgoing recorded message to an initiating phone number associated with the phone call.

24. The system of claim 18, wherein an initiating phone number associated with the phone call is a disconnected phone number.

25. The system of claim 18, wherein:
a receiving phone number associated with the phone call is a disconnected phone number; and
intercepting the phone call comprises intercepting the phone call based at least in part on the receiving phone number being a disconnected phone number stored within a data store of disconnected phone numbers.

26. The system of claim 18, wherein the actions further comprise:
recording the entire phone call; and
storing a recording of the entire phone call within a second data store.
